(19) United States
(12) Patent Application Publication
(10) Pub. No.: US 2024/0111773 A1
(43) Pub. Date: Apr. 4, 2024

(54) Computer Memory Management With Efficient Index Access

(71) Applicant: International Business Machines Corporation, Armonk, NY (US)

(72) Inventors: Shuo Li, Beijing (CN); Xiaobo Wang, Beijing (CN); Sheng Yan Sun, Beijing (CN); YING ZHANG, Beijing (CN)

(21) Appl. No.: 17/936,454

(22) Filed: Sep. 29, 2022

(51) Int. Cl. G06F 16/2455; G06F 11/34; G06F 16/22

(52) U.S. Cl. CPC G06F 16/24562; G06F 11/3419; G06F 16/2246; G06F 16/2272; G06F 16/24552

(57) ABSTRACT

Computer technology for retrieving data stored in a table that includes the following computer operations: receiving, from persistent storage of a computer, an original Index Tree data structure; storing, in volatile memory, a memory-based Index Tree data structure based on the original Index Tree data structure, with the memory-based Index Tree data structure including: a root node, a set of hierarchically arranged intermediate layer(s) with each intermediate layer including a plurality of non-leaf nodes, and a leaf layer including a plurality of leaf nodes; and retrieving data from a table in a database, with the retrieval including traversing the memory-based Index Tree data structure through a plurality of child lock pointers to locate pages including the data to be retrieved from the table.

### BACKGROUND

The present invention relates generally to the field of accessing an index of a table (for example, a table making up part of a database) in a random access memory (RAM) and also to the field of software based index managers.

List prefetch access paths are well suited for queries where the qualified rows, as determined in index key sequence are skip-sequential but sparse (that is, not sequential). List prefetch access paths can be used with either access of a single index or access of multiple indices. When performing a hybrid join operation, if the index is highly clustered, the page numbers might not be sorted before accessing the data. Those of skill in the art understand that list prefetch access paths can be used with most matching predicates for an index scan.

### SUMMARY

According to an aspect of the present invention, there is a method, computer program product and/or system that performs the following operations (not necessarily in the following order): receiving, from persistent storage of a computer, an original Index Tree data structure; storing, in volatile memory, a memory-based Index Tree data structure based on the original Index Tree data structure, with the memory-based Index Tree data structure including: a root node, a set of hierarchically arranged intermediate layer(s) with each intermediate layer including a plurality of non-leaf nodes, and a leaf layer including a plurality of leaf nodes; and retrieving data from a table in a database, with the retrieval including traversing the memory-based Index Tree data structure through a plurality of child lock pointers to locate pages including the data to be retrieved from the table.

### BRIEF DESCRIPTION OF THE DRAWINGS

FIG. 1 is a block diagram of a first embodiment of a system according to the present invention;

FIG. 2 is a block diagram showing a machine logic (for example, software) portion of the first embodiment system;

FIG. 3 is a flowchart showing a first embodiment method performed, at least in part, by the first embodiment system;

FIG. 4 is a detailed view of a volatile memory included in the first embodiment computer system;

FIG. 5 is a block diagram of a second embodiment of a system according to the present invention;

FIG. 6 is a flowchart showing a second embodiment method performed, at least in part, by the second embodiment system;

FIG. 7 is a diagram of an Index Tree that may be used in various embodiments of the present invention;

FIG. 8 is another diagram of an Index Tree that may be used in various embodiments of the present invention; and

FIG. 9 is a block diagram that shows how an Index Tree data structure may be accessed in various embodiments of the present invention.

### DETAILED DESCRIPTION

This Detailed Description section is divided into the following subsections: (i) The Hardware and Software Environment; (ii) Example Embodiment; (iii) Further Comments and/or Embodiments; and (iv) Definitions.

### I. THE HARDWARE AND SOFTWARE ENVIRONMENT

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

As shown in the first Figure of this document, computing environment 100 contains an example of an environment for the execution of at least some of the computer code involved in performing the inventive methods, such as list prefetch module 200 (also herein sometimes referred to as block 200). In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

### II. EXAMPLE EMBODIMENT

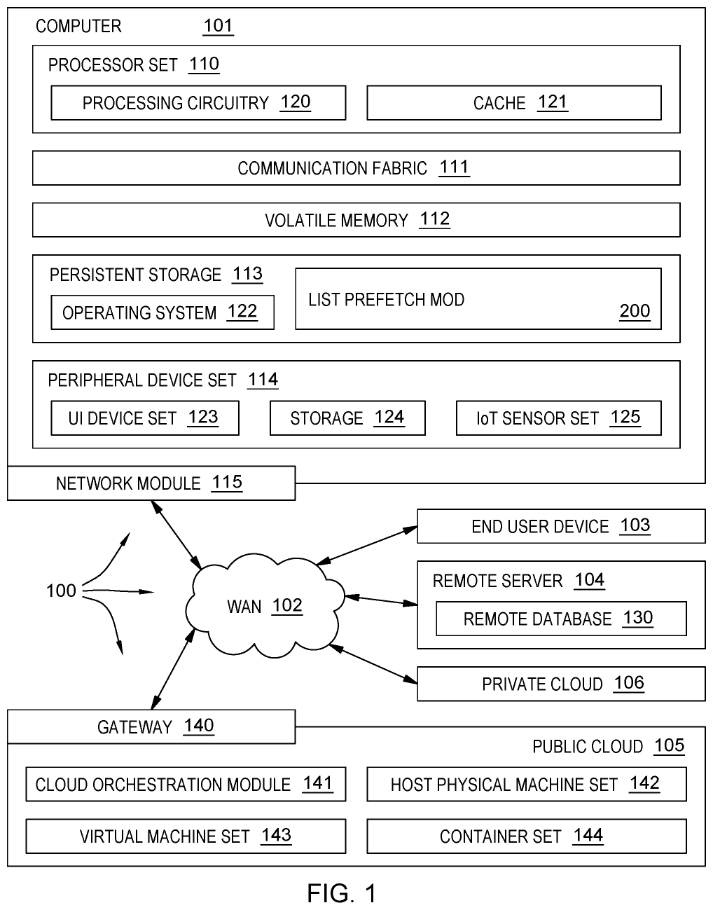

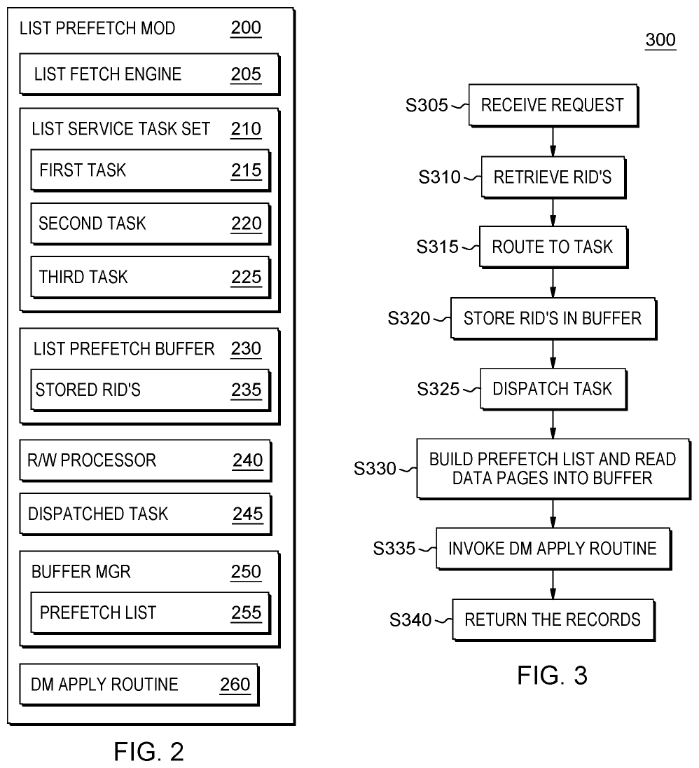

Computing environment 100 is an environment in which an example method for an improved list prefetch operation according to the present invention can be performed. As shown in FIG. 3, flowchart 300 shows an embodiment of the list prefetch method according to the present invention. As shown in FIG. 2, list prefetch mod 200 performs or controls performance of at least some of the method operations of flowchart 250. This method and associated software will now be discussed, over the course of the following paragraphs, with extensive reference to the blocks of FIGS. 1, 2 and 3.

Processing begins at operation S305, where a database engine (not separately shown, but see remote database 130 in FIG. 1) sends a request to list prefetch engine 205 to read the records within a set of rows specified in the request. Typically, the rows of the database specified in the request will be non-consecutive. The set of rows is sometimes referred to as a “range” even if the rows are not consecutive rows in the database table.

Processing proceeds to operation S310, where list prefetch engines retrieves RIDs (record id's) on the range specified in the request. Typically, the “range” of the request will include separate sub-ranges, each having one or more consecutive rows within the sub-range.

Processing proceeds to operation S315, where the list prefetch engine routes the RIDs identified in operation S310 to the appropriate list prefetch service task. In this example, the appropriate list prefetch service task is first task 215 of service task set 210.

Processing proceeds to operation S320, where the RIDs are stored in list prefetch buffer 230 as stored RID's 235. When the list prefetch buffer is full or reach the end, the list prefetch buffer is then sorted in sequence as part of operation S320. In this example, the appropriate list prefetch service task is second task 220 of service task set 210.

Processing proceeds to operation S325, where, for each RID stored in the list prefetch buffer, read/write processor 240 dispatches a task (see, for example, dispatched task 245) and communicates the range (or sub-range) to the newly dispatched task. In this example, the appropriate list prefetch service task is third task 225 of service task set 210.

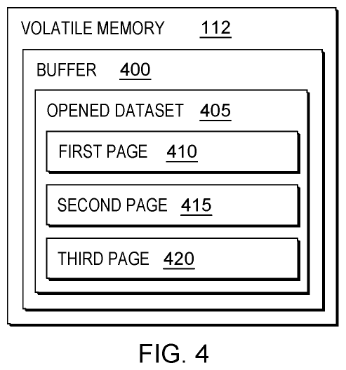

Processing proceeds to operation S330, each dispatched RID task (for example, dispatched task 245) opens a dataset (see opened data set 405) including pertinent portions of the rows of a table in the database (see remote database 130) and builds prefetch list 255 and passes it to buffer manager 250 to read the pages of data from the database table into buffer 400 located in volatile memory 112. This is shown in FIG. 4, where first page 410, second page 415 and third page 420 of opened dataset 405 have been stored in the buffer.

Processing proceeds to operation S335, where each dispatched task (see dispatched task 245, for example) invokes DM (data management) apply routine 260 to apply the records stored in buffer 400.

Processing proceeds to operation S340, where DM apply routine 260 returns to records the corresponding dispatched task (see dispatched task 245, “dispatched tasks are sometimes herein referred to as “apply tasks”) to return the records to the requester who sent the request at operation S305. With this novel method of flowchart 300, the list prefetch can be improved.

### III. FURTHER COMMENTS AND/OR EMBODIMENTS

Some embodiments of the present invention recognize one, or more, of the following facts, potential problems and/or potential areas for improvement with respect to the current state of the art: (i) list prefetch has to catch up all the RID (RECORD ID) retrieved by an index for a table in a database, but sometimes the list prefetch operation will be fail which can lead to degraded performance; (ii) there is a need to introduce computer technology to improve the performance of list prefetch operation; (iii) there is a need to build up channels for the list prefetch so that the prefetch will acquire a given record depending on the bucket in which the record is included; (iv) in the each bucket, the RIDs can be accessed separately; and/or (v) addressing the foregoing items in this list can potentially reduce the cost on the whole prefetch process.

Getting data from a table in a database typically a traverse down an Index Tree, which is a tree structure having multiple layers that are hierarchically arranged and connected. For example, an Index Tree may include five (5) layers as follows: ROOT, intermediate layer N1, intermediate layer N2, intermediate layer N3 and LEAF layer. The ROOT level has only a single node, but the lower levels of the Index Tree will typically have multiple nodes, with the number of nodes increasing at each successive layer. Each node in the Index Tree, other than leaf level nodes at the lowest LEAF level of the tree represents a data page in a bufferpool. Retrieving data from a table in a database typically requires a traversal down the Index Tree from the ROOT level down through the appropriate nodes at each intermediate layer and then down to the LEAF node. In the example with a five (5) layer Index Tree, assuming non-leaf pages in buffer pool will typically require five (5) getpage operations. Leaf page and data page each typically require a getpage operation and an input/output operation. Below is some sample code for doing this:

```
Lock Page P1 X
GetPage P1
    BP Miss - Read P1 from storage / disk
    BP Hit - Use Page
Latch P1 X
Read Data Page
Unlatch P1
RelPage P1
Commit
  Release locks
```

Some embodiments of the present invention provide computer technology for faster access to the Index Tree, by building a tree data structure that resides in volatile memory (for example RAM) of the computer. This new data structure can be used in the way that conventional Index Trees are used, but the new tree form data structure resides in volatile memory, rather than non-volatile storage. By making a copy of the Index Tree, and/or a new version that is effectively equivalent to the original Index Tree, in volatile memory, this tends to reduce communications required between the index manager and portion of the Index Tree temporarily stored in the bufferpool, which can increase performance and reduce costs.

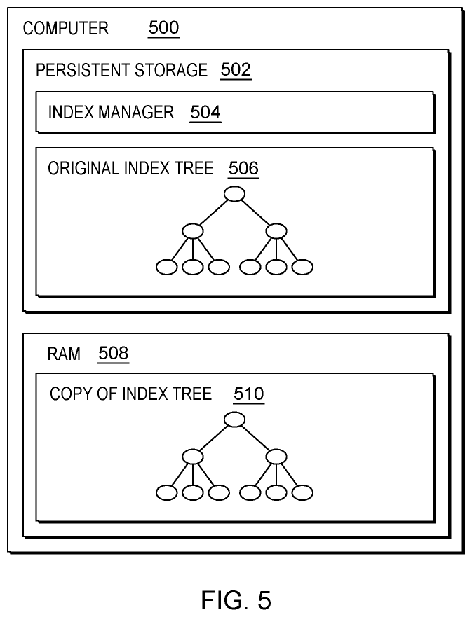

As shown in FIG. 5, computer 500 includes: persistent storage 502 (including index manager 502 and original Index Tree 506) and RAM 508 (including bufferpool 512 and copy of Index Tree 510). In this embodiment, copy of Index Tree 510 is the new data structure that is stored in volatile memory, instead of being stored in persistent storage. Index Manager 504 can directly access the dedicated copy of the Index Tree in RAM more quickly than it could access the original Index Tree through the bufferpool. This reduces or eliminates computationally intensive getpage operations when traversing down the index tree from the ROOT level and down through the intermediate levels. It is noted that retrieval of actual data from a table will still require getpage operation(s) as data page(s) are retrieved from persistent storage where the table is stored (see, for example, FIG. 1 at remote database 130).

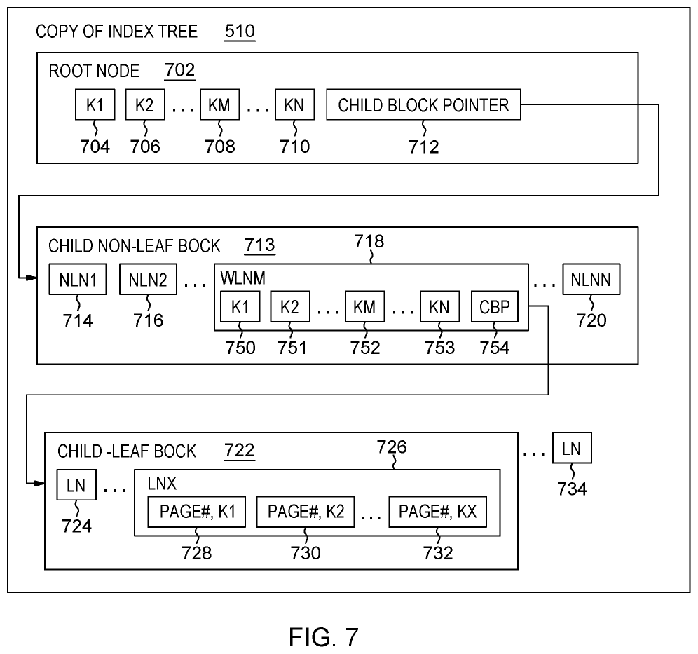

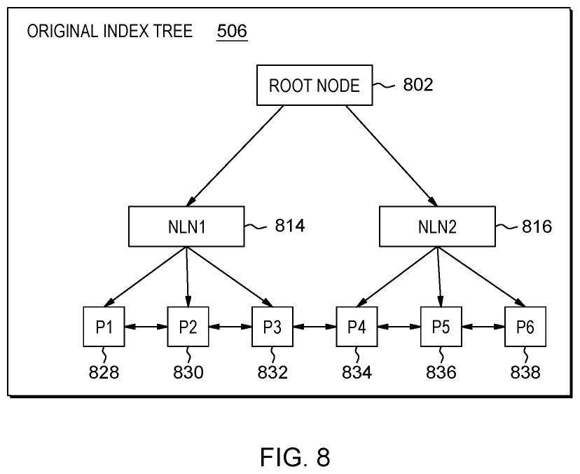

As will be appreciated by comparing FIG. 8 (original Index Tree 506) and FIG. 7 (copy of Index Tree 510), the copy of Index Tree in volatile memory is not exactly the same data structure as original Index Tree 506. As shown in FIG. 8, original Index Tree 506 includes: root node 802; non-leaf node1 814; non-leaf node 816; page 1 828; page2 830; page3 832; page4 834; page5 836; and page6 838. As shown in FIG. 7, copy of Index Tree 510 includes: root node 702; key1 704; key2 706; keyM 708; keyN 710; child block pointer 712; child non-leaf block 713; non-leaf node1 714; non-leaf node2 716; non-leaf nodeM 718 (including key1 750, key2 751, keyM 752, keyN 753 and child block pointer 754); non-leaf nodeN 720; child leaf block 722; leaf nodeN 724; leaf node X 726 (including page #, key1 block 728, page #, key2 block 730 and page #, keyX block 732; and leaf node 734. As shown by arrows in FIG. 7, the tree is traversed starting at root node 702, down to child non-leaf block 713 at an intermediate level of the tree, and finally down to child leaf block 722 at the leaf level. The data structure of copy of Index Tree 506 is built depending on the B tree with non-leaf page(s).

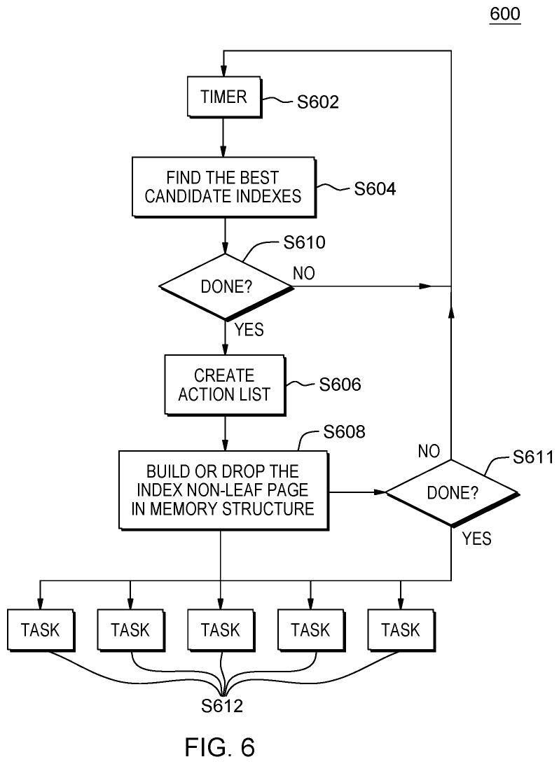

As shown in FIG. 6, a method for building copy of index tree 510 is shown by flowchart 600. Processing starts at operation S602 where a timer is set. Processing proceeds to operations S604 and S610, where the timer is periodically reset until the best candidate indices are found. After it is determined that the best candidate indices have been found, processing proceeds to operation S606, where an action list is created. Processing proceeds to operation S608 where: (i) the timer is again set, and (ii) a non-leaf page of original Index Tree 506 is built or dropped into copy of Index Tree 510. As shown by operation S611, if the process is not finished, then processing proceeds back to operation S602. On the other hand, if the building/dropping operation is completed, then processing proceeds to a set of tasks S612 that utilize copy of newly-built Index Tree 510. In the method of flowchart 600: (i) the candidate indices are checked every period; (ii) statistics are checked (for example, check in real-time) by reading and splitting times; and (iii) the following criteria are used to choose the index: (a) index length is not too big, (b) an index that is accessed by a relatively large number of read operations, and (c) the index does not take up too much storage.

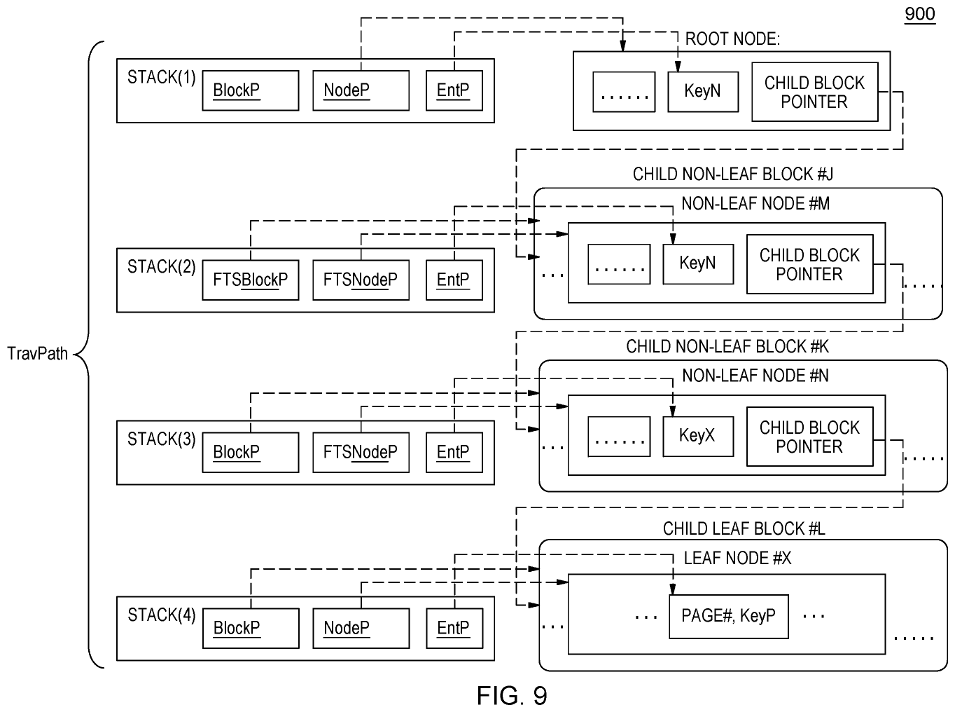

As shown in FIG. 9, block diagram 900 shows that, in some embodiments, read path are stored in a stack for retraversing copy of Index Tree 510. In diagram 900, a key insert is made at a node split. Alternatively, in some embodiments, the key insert is made without a node split by making a T1 insert.

In most instances of read/traversals operations performed on copy of Index Tree 506, no lock/latch is required main scenario because the data of the index is not located in the bufferpool and managed as part of the bufferpool. This may be the case for approximately 99% of the read/traversal operations. For instances of write/insert operations, no lock/latch is required—however, in rare scenarios, only one thread will allow a write operation, which may necessitate a lock/latch to be performed.

In a write operation according to the present invention, a 2-use count defined as (Count1, Count2) as follows: (i) before insert, Count1=Count1+1; (ii) perform insert; and (iii) after insert, Count2=Count2+1. In a read operation according to the present invention as follows: (i) before read, set readCount with Count2; (ii) perform traverse of copy of Index Tree 510; and (iii) after read, compare readCount with Count1. In some embodiments, use of a MESI protocol guarantees consistency in a multi CPU (central processing unit) system structure.

Some embodiments use CS (compiler shell) group compiler command to avoid the necessity of setting a latch. In some embodiments, a COMPARE AND SWAP command can be used by CPU programs sharing common storage areas in either a multiprogramming or multiprocessing environment to protect the memory operations being performed on copy of Index Tree 510 in the volatile memory.

In some instances, an insert is made with a node split, but without block split by: (i) inserting a key in the parent node; and (ii) adding the new key into the key sequence so that the key sequence is scattered between two nodes as a T1 insert and a T2 insert. In other instances, there may be a block split, in which case only a T1 insert is used. For block split, the index access thread has to control blocks by an internal management structure. In this case, the operation should be monitored by the thread for the new method.

Some potential advantages of various embodiments of the present invention are: (i) better index access performance; (ii) reduction of the length of a code path for index access; (iii) uses index manager internal structure for accessing the Index Tree instead of accessing buffer pool to traverse the Index Tree; (iv) reduces CPU and input/output usage; (v) reduces lock and latch usage; (vi) shorter code paths with fewer CPU operations; and/or (vii) fewer requests for the index pages.

Some embodiments of the present invention may include one, or more, of the following advantages, features and/or computer operations: (i) receiving a plurality of candidate indices and selecting a most suitable index based on time period; (ii) a novel data structure, for holding an Index Tree in volatile memory, that includes index non-leaf keys; (iii) a novel data structure, for holding an Index Tree in volatile memory, that includes a plurality of blocks and a plurality of nodes structured to require fewer memory operations when the Index Tree is accessed to retrieve data from a table; (iv) a read stack is built to save access paths for re-traverse; (v) use count operations, instead of lock and latch operations, to reduce CPU usage and/or increase speed; (vi) a novel data structure, for holding an Index Tree in volatile memory, that is amenable to the operation of splitting a key insert without any node split; (vii) performing CS group operations, when accessing an Index Tree in a volatile memory to avoid latch operations that would otherwise occur; (viii) a novel data structure, for holding an Index Tree in volatile memory, that is amenable to the operation of splitting a key insert with node split but without block split; (ix) parent block modification and node split; (x) splitting a key insert with a block split; and/or (x) storage management for efficient usage including pool management and control block usage.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein are believed to potentially be new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

And/or: inclusive or; for example, A, B “and/or” C means that at least one of A or B or C is true and applicable.

Including/include/includes: unless otherwise explicitly noted, means “including but not necessarily limited to.”

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Set of thing(s): does not include the null set; “set of thing(s)” means that there exist at least one of the thing, and possibly more; for example, a set of computer(s) means at least one computer and possibly more.

What is claimed is:

1. A computer-implemented method (CIM) comprising:
receiving, from persistent storage of a computer, an original Index Tree data structure, with the original Index Tree Structure including: a root node, a set of hierarchically arranged intermediate layer(s) with each intermediate layer including a plurality of non-leaf nodes, and a leaf layer including a plurality of leaf nodes;
storing, in volatile memory, a memory-based Index Tree data structure based on the original Index Tree data structure, with the memory-based Index Tree data structure including: a root node, a set of hierarchically arranged intermediate layer(s) with each intermediate layer including a plurality of non-leaf nodes, and a leaf layer including a plurality of leaf nodes; and
retrieving data from a table in a database, with the retrieval including traversing the memory-based Index Tree data structure through a plurality of child lock pointers to locate pages including the data to be retrieved from the table.

2. The CIM of claim 1 further comprising:
receiving a plurality of candidate Index Tree data structures; and
selecting a most suitable index based on time period to use as the original Index Tree data structure.

3. The CIM of claim 1 wherein:
and a child block pointer that points to a first child non-leaf block that corresponds to a first intermediate level of the set of hierarchically arranged intermediate layer(s);
each intermediate layer of the set of hierarchically arranged intermediate layer(s) of the memory-based Index Tree data structure is in the form of a child non-leaf block that includes a plurality of non-leaf nodes and a child block pointer; and
each non-leaf node of the plurality of non-leaf nodes of the memory-based Index Tree data structure includes a plurality of keys and a child block pointer that points to a block corresponding to a next lower layer of the hierarchy.

4. The CIM of claim 1 wherein the memory-based Index Tree data structure includes a plurality of index non-leaf keys.

5. The CIM of claim 1 wherein the memory-based Index Tree data structure includes a plurality of blocks and a plurality of nodes structured to require fewer memory operations when the Index Tree is accessed during retrieval of data from the data in the database.

6. The CIM of claim 1 further comprising:
generating a plurality of access paths during traversals of the memory-based Index Tree; and
building a read stack to store the plurality of access paths for re-traverse.

7. The CIM of claim 1 wherein the retrieval uses a count operation and thereby avoids use of a latch operation.

8. The CIM of claim 1 wherein the retrieval includes splitting a key insert without any node split.

9. The CIM of claim 1 wherein the retrieval includes splitting a key insert with node split while avoiding any block split.

10. The CIM of claim 1 wherein the retrieval includes splitting a key insert with a block split.

11. A computer program product (CPP) comprising:
a set of storage device(s); and
computer code stored collectively in the set of storage device(s), with the computer code including data and instructions to cause a processor(s) set to perform at least the following operations:
receiving, from persistent storage of a computer, an original Index Tree data structure, with the original Index Tree Structure including: a root node, a set of hierarchically arranged intermediate layer(s) with each intermediate layer including a plurality of non-leaf nodes, and a leaf layer including a plurality of leaf nodes;
storing, in volatile memory, a memory-based Index Tree data structure based on the original Index Tree data structure, with the memory-based Index Tree data structure including: a root node, a set of hierarchically arranged intermediate layer(s) with each intermediate layer including a plurality of non-leaf nodes, and a leaf layer including a plurality of leaf nodes, and
retrieving data from a table in a database, with the retrieval including traversing the memory-based Index Tree data structure through a plurality of child lock pointers to locate pages including the data to be retrieved from the table.

12. The CPP of claim 11 wherein the computer code further includes data and instructions for:
receiving a plurality of candidate Index Tree data structures; and
selecting a most suitable index based on time period to use as the original Index Tree data structure.

13. The CPP of claim 11 wherein:
and a child block pointer that points to a first child non-leaf block that corresponds to a first intermediate level of the set of hierarchically arranged intermediate layer(s);
each intermediate layer of the set of hierarchically arranged intermediate layer(s) of the memory-based Index Tree data structure is in the form of a child non-leaf block that includes a plurality of non-leaf nodes and a child block pointer; and
each non-leaf node of the plurality of non-leaf nodes of the memory-based Index Tree data structure includes a plurality of keys and a child block pointer that points to a block corresponding to a next lower layer of the hierarchy.

14. The CPP of claim 11 wherein the memory-based Index Tree data structure includes a plurality of index non-leaf keys.

15. The CPP of claim 11 wherein the memory-based Index Tree data structure includes a plurality of blocks and a plurality of nodes structured to require fewer memory operations when the Index Tree is accessed during retrieval of data from the data in the database.

16. The CIM of claim 11 further comprising:
generating a plurality of access paths during traversals of the memory-based Index Tree; and
building a read stack to store the plurality of access paths for re-traverse.

17. The CPP of claim 11 wherein the retrieval uses a count operation and thereby avoids use of a latch operation.

18. The CPP of claim 11 wherein the retrieval includes splitting a key insert without any node split.

19. A computer system (CS) comprising:
a processor(s) set;
a set of storage device(s); and
computer code stored collectively in the set of storage device(s), with the computer code including data and instructions to cause the processor(s) set to perform at least the following operations:
receiving, from persistent storage of a computer, an original Index Tree data structure, with the original Index Tree Structure including: a root node, a set of hierarchically arranged intermediate layer(s) with each intermediate layer including a plurality of non-leaf nodes, and a leaf layer including a plurality of leaf nodes;
storing, in volatile memory, a memory-based Index Tree data structure based on the original Index Tree data structure, with the memory-based Index Tree data structure including: a root node, a set of hierarchically arranged intermediate layer(s) with each intermediate layer including a plurality of non-leaf nodes, and a leaf layer including a plurality of leaf nodes, and
retrieving data from a table in a database, with the retrieval including traversing the memory-based Index Tree data structure through a plurality of child lock pointers to locate pages including the data to be retrieved from the table.

20. The CPP of claim 11 wherein:
and a child block pointer that points to a first child non-leaf block that corresponds to a first intermediate level of the set of hierarchically arranged intermediate layer(s);
each intermediate layer of the set of hierarchically arranged intermediate layer(s) of the memory-based Index Tree data structure is in the form of a child non-leaf block that includes a plurality of non-leaf nodes and a child block pointer; and
each non-leaf node of the plurality of non-leaf nodes of the memory-based Index Tree data structure includes a plurality of keys and a child block pointer that points to a block corresponding to a next lower layer of the hierarchy.
